(19) United States
(12) Patent Application Publication
(10) Pub. No.: US 2023/0342265 A1
(43) Pub. Date: Oct. 26, 2023

(54) CLOUD AWARE FILE SYSTEM RESTORES

(71) Applicant: Dell Products L.P., Round Rock, TX (US)

(72) Inventors: Sunil Yadav, Bangalore (IN); Manish Sharma, Bangalore (IN); Aaditya Bansal, Bangalore (IN); Shelesh Chopra, Bangalore (IN)

(21) Appl. No.: 17/724,616

(22) Filed: Apr. 20, 2022

(51) Int. Cl. G06F 11/14

(52) U.S. Cl. CPC G06F 11/1469; G06F 11/1464; G06F 2201/84

(57) ABSTRACT

In accordance with one or more embodiments of the invention, when restoring data from a backup that is at least partially stored on the cloud, the meta-data and data forming the backup are not in sync with the local meta-data. When restoring the data, once the backup data and backup data is copied to the desired location on the production host, the backup data and backup meta-data need to be linked back up. Once the backup data and backup meta-data is copied to the target production host, the backup meta-data is linked with the backup data and then the restoration is indicated as having been completed. By performing the linkage during the restoration, prior to the restore being indicated as being complete, delays in production workloads and productivity can be avoided.

### BACKGROUND

As people increasingly rely on computing systems and devices to perform many tasks; the systems have become increasingly complex, and the opportunities for failure and/or loss of important data has also increased. To prevent loss of important data, performing a backup on the file system of a computing system is necessary to prevent loss of data if a system failure occurs or cyberattacks such as ransomware are directed towards the system. Filesystem backups leverage a file-based backup philosophy to protect the underlying data. This underlying mechanism is leveraged not just to protect the filesystem on a host, but also to protect workflows in network attached storage.

Increasingly data and IT needs are being migrated to external servers, storage, and service providers such as what is called the: “cloud.” One of the uses of cloud-based storage, is to function as an off-site backup storage. At least one copy of the backup data is stored on the cloud. When restoration of the backup is needed, backup data from the cloud is needed to completely restore data to the local computing system.

### SUMMARY

In general, certain embodiments described herein relate to a method for restoring data from a backup. The method begins by identifying a backup to restore on to a production host. Once the backup is identified, the method identifies backup meta-data for the backup. In one or more embodiments of the invention the backup data for the backup is located on a cloud storage. The method then retrieves the backup data from the cloud storage and stores this backup data and the backup meta-data on the production host. Once the backup data and backup meta-data are stored on the production host, the method initiates linking of the backup meta-data and the backup data on the production host. The method results in the data being restored once the linking is completed.

In general, certain embodiments described herein relate to a non-transitory computer readable medium comprising computer readable program code, which when executed by a computer processor enables the computer processor to perform a method for restoring data from a backup. The method begins by identifying a backup to restore on to a production host. Once the backup is identified, the method identifies backup meta-data for the backup. In one or more embodiments of the invention the backup data for the backup is located on a cloud storage. The method then retrieves the backup data from the cloud storage and stores this backup data and the backup meta-data on the production host. Once the backup data and backup meta-data are stored on the production host, the method initiates linking of the backup meta-data and the backup data on the production host. The method results in the data being restored once the linking is completed.

In general, certain embodiments described herein relate to a system comprising: a cloud storage device and at least one production host. The at least one production host comprises a processor, a local storage device, and a memory. The memory includes instructions, which when executed by the processor, perform a method for restoring data from a backup. The method begins by identifying a backup to restore on to the at least one production host. Once the backup is identified, the method identifies backup meta-data for the backup. In one or more embodiments of the invention the backup data for the backup is located on a cloud storage. The method then retrieves the backup data from the cloud storage and stores this backup data and the backup meta-data on the at least one production host. Once the backup data and backup meta-data are stored on the at least one production host, the method initiates linking of the backup meta-data and the backup data on the at least one production host. The method results in the data being restored once the linking is completed.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a backup system in accordance with one or more embodiments of the invention.

FIG. 3 shows a flowchart of a method for restoring a backup to a production host in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures.

In the following description of the figures, any component described with regards to a figure, in various embodiments of the invention, may be equivalent to one or more like-named components described with regards to any other figure. For brevity, descriptions of these components will not be repeated with regards to each figure. Thus, every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regards to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or preceded) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, in accordance with one or more embodiments of the invention, when restoring data from a backup that is at least partially stored on the cloud, the meta-data and data forming the backup may not be in sync with the local meta-data. When restoring the data, once the backup data and backup meta-data is copied to the desired location on the production host, the backup data and backup meta-data need to be linked back up. In accordance with one or more embodiments of the invention, once the backup data and backup meta-data is copied to the target production host, the backup meta-data is linked with the backup data and then the restoration is indicated as having been completed. By performing the linkage during the restoration, prior to the restoration being indicated as being complete, delays in production workloads and productivity can be avoided.

The following describes various embodiments of the invention.

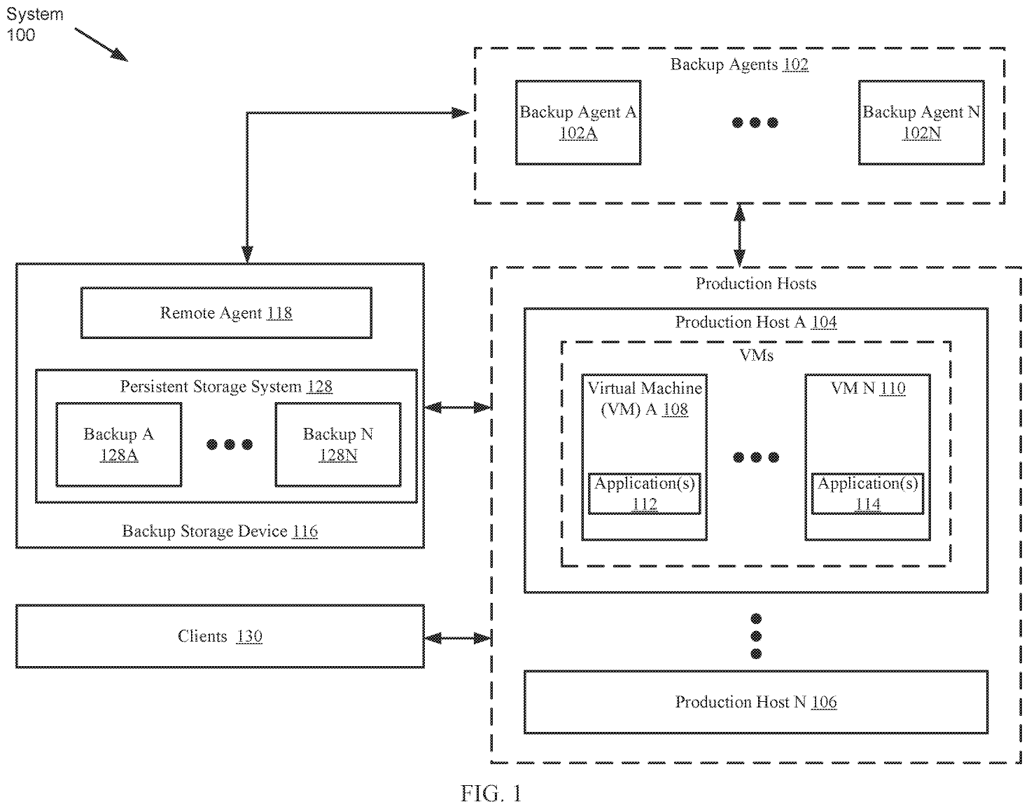

FIG. 1 shows a diagram of a system (100) in accordance with one or more embodiments of the invention. The system includes backup agents (102), production hosts (e.g., 104, 106), a backup storage device (116), a remote agent (118), and clients (130). The system may include additional, fewer, and/or different components without departing from the scope of the invention. Each component may be operably connected to any of the other component via any combination of wired and/or wireless connections. Each component illustrated in FIG. 1 is discussed below.

In one or more embodiments of the invention, the backup agents (e.g., 102A, 102N) may generate and provide to the backup storage device (116) the backups and the historical meta-data based on backup policies implemented by the backup agent (102). In one or more embodiments of the invention, at least one of the backup agents (e.g., 102A, 102N) can take the form of a volume snapshot or shadow copy service (VSS). The backup agents (e.g., 102A, 102N) can take other forms such as an archiving agent, a file system agent, or any other related agent, without departing from the invention.

The backup storage device (116) may comprise of local storage such as one or more hosts, or a separate system and/or external storage such as that located in a cloud. The backup policies may specify a schedule in which the applications (e.g., 114) or other assets associated with the applications are to be backed up. The backup agent (102) may be triggered to generate a backup and historical meta-data and provide the backup and historical meta-data to the backup storage device (116) in response to a backup policy. Alternatively, backup, and historical meta-data may be generated by the backup agent (102) and provided to the backup storage device (116) in response to a backup request triggered by a user or administrator and/or a client. The backup request may specify the applications(s) (114) and/or assets associated with the applications (114) to be backed up.

In one or more embodiments of the invention, the backup agent (102) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup agent (102) described throughout this application.

In one or more embodiments of the invention, the backup agent (102) is implemented as computer instructions, e.g., computer code, stored on a persistent storage that when executed by a processor of the production hosts (e.g., 104, 106) causes the production hosts (e.g., 104, 106) to provide the functionality of the backup agents (102) described throughout this application.

In one or more embodiments of the invention, the production host (e.g., 104, 106), hosts one or more applications (e.g., 112, 114). In one or more embodiments of the invention, the application(s) (e.g., 112, 114) perform computer implemented services for clients (e.g., 130). Performing the computer implemented services may include performing operations on asset data that is stored in the production host (e.g., 104). The operations may include creating elements of assets, moving elements of assets, modifying elements of assets, deleting elements of assets, and other and/or additional operations on asset data without departing from the invention. The application(s) (e.g., 112, 114) and/or users of the client(s) (130) may include functionality for performing the aforementioned operations on the asset data in the production host (e.g., 104, 106). The application(s) (e.g., 112, 114) may be, for example, instances of databases, email servers, and/or other applications. The production host (e.g., 104, 106) may host other types of applications without departing from the invention.

In one or more of embodiments of the invention, the application(s) (e.g., 112, 114) is implemented as computer instructions, e.g., computer code, stored on a persistent storage that when executed by a processor(s) of the production hosts (e.g., 104, 106) cause the production host (e.g., 104, 106) to provide the functionality of the application(s) (e.g., 112, 114) described throughout this application.

The production hosts (e.g., 104, 106) may include physical storage or logical storage. One or more of the production hosts (104-106), may be externally located on a cloud or other external location. The logical storage devices (e.g., virtualized storage) may utilize any quantity of hardware storage resources of any number of computing devices for storing data. For example, the persistent storage may utilize portions of any combination of hard disk drives, solid state disk drives, tape drives, and/or any other physical storage medium of any number of computing devices.

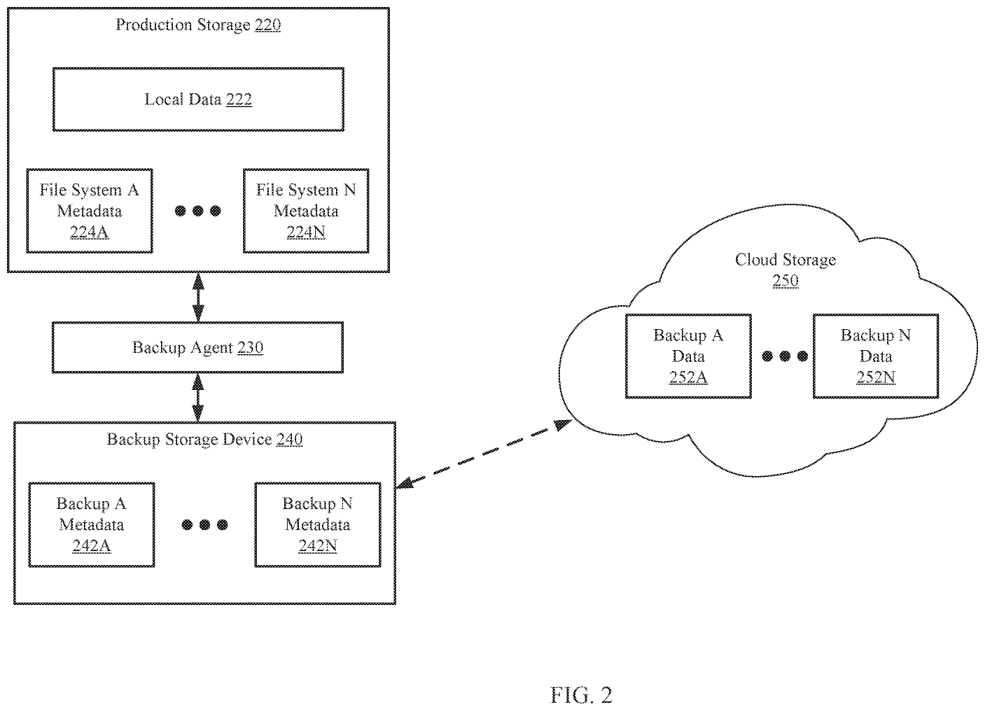

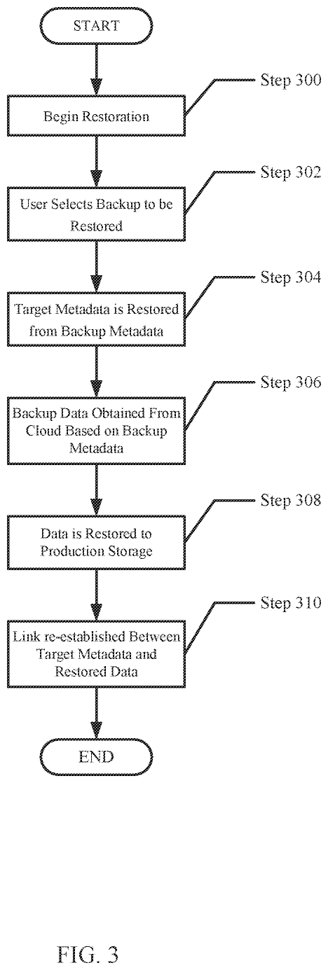

In one or more embodiments of the invention, the backup agents (102) may be a portion of the remote agents (118). The remote agents (118) and/or backup agents (102) may provide backup services to the production hosts (e.g., 104, 106). The backup services may include generation and storage of backups in the backup storage device (116). The backups services may also include restoration of the production hosts (e.g., 104, 106) using the backups stored in the backup storage device (116) and/or on external servers (not shown) such as cloud storage, which will be described in more detail with regards to FIGS. 2 and 3.

The remote agents (118) may provide backup services to the production hosts (e.g., 104, 106) by orchestrating: (i) generation of backups of the production hosts (e.g., 104, 106), (ii) storage of backups (e.g., 128A, 128N) of the production hosts (e.g., 104, 106) in the persistent storage system (128) of the backup storage device (116), (iii) consolidation of backup requests to reduce or prevent from generation of backups that are not useful for restoration purposes, and (iv) restoration of the production hosts (e.g., 104, 106) to previous states using backups (e.g., 128A, 128N) stored in the persistent storage system (128) of the backup storage device (116). The system may include any number of remote agents (e.g., 102A, 102N) without departing from the scope of the invention.

Additionally, to provide the backup services, the remote agent (118) may include functionality to generate and issue instructions to any component of the system of FIG. 1. In one or more embodiments, the remote agent (118) may also generate instructions in response to backup requests from other entities.

In one or more embodiments of the invention, the remote agent (118) may generate such instructions in accordance with backup schedules that specify when backups are to be generated. In one or more embodiments, a backup schedule may lay out specific points in time for a backup process to be performed.

In one or more embodiments of the invention, to satisfy the above-discussed backup schedules, the remote agent (118) may monitor a backup window (e.g., 4 hours, 8 hours, etc.) to perform a single backup and/or multiple backups. Additionally, the remote agent (118) may pause an ongoing backup if the backup exceeded the backup window. The remote agent (118) may then resume the paused backup while performing a next backup in a parallel manner based on the backup schedule.

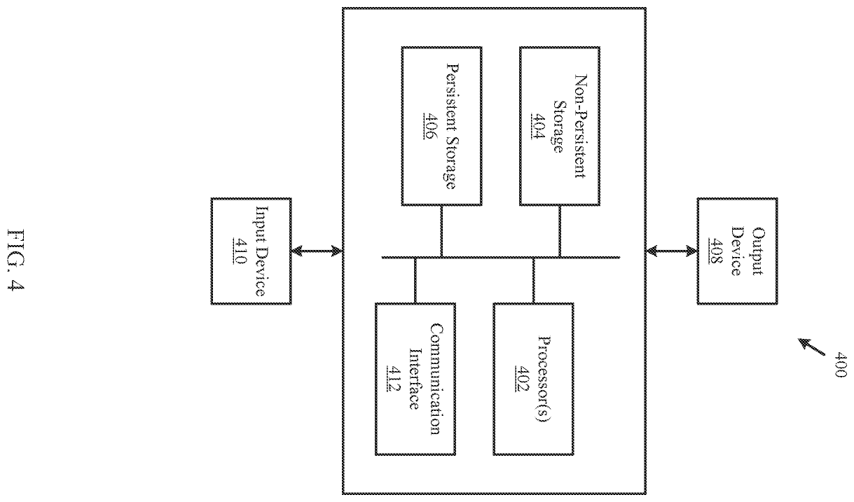

In one or more embodiments of the invention, the system (100) may be implemented as one or more computing devices (e.g., 400, FIG. 4). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the various parts of the system (100) described throughout this application.

Alternatively, in one or more embodiments of the invention, the various parts of the system (100) may be implemented as logical devices. A logical device may utilize the computing resources of any number of computing devices to provide the functionality of the various parts of the system (100) described throughout this application.

In one or more embodiments of the invention, the backup storage device (116) may provide data storage services. For example, the backup storage device (116) may store backups of the production hosts (e.g., 104, 106) in persistent storage system (128), which in one or more embodiments of the invention includes persistent storage that is not local to the production hosts and/or is located on a cloud. The persistent storage system (128) may also provide copies of the latest backup N (128N) previously stored backups (128A) of the production hosts (e.g., 104, 106). The system may include any number of backup storage devices (116) and backups (e.g., 128A, 128N) without departing from the scope of the invention.

In one or more embodiments of the invention, the backup storage device (116) and persistent storage system (128) may be implemented as computing devices (e.g., 400, FIG. 4). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the backup storage device (116) described throughout this application.

Alternatively, in one or more embodiments of the invention, the backup storage devices (116) may also be implemented as logical devices, as discussed above.

In one or more embodiments of the invention, the production hosts (e.g., 104, 106) may provide services to the clients (130). For example, the production hosts (e.g., 104, 106) may host any number of applications that provide application services to the clients (130). Application services may include, but are not limited to database services, electronic communication services, instant messaging services, file storage services, etc.

In one or more embodiments of the invention, each of the production hosts (e.g., 104, 106) may provide the above-discussed application services by hosting applications. Each of the production hosts may host any number of applications. Additionally, different production hosts may host the same number of applications or different numbers of applications. Different production hosts may also host similar or different applications.

In one or more embodiments of the invention, the production hosts (e.g., 104, 106) may host virtual machines (VMs, e.g., 108-110) that host the above-discussed applications. Each of the production hosts (e.g., 104, 106) may host any number of VMs that, in turn, host any number of applications.

In one or more embodiments of the invention, the production hosts (e.g., 104, 106) may perform portions of a backup process. For example, the production hosts (e.g., 104, 106) may initiate backups under the direction of the remote agent (118) or backup agents (102). In one or more embodiments, the production hosts (e.g., 104, 106) may include functionality to consolidate multiple backup generation requests so that duplicative backups are not generated, because the duplicative backups may not be useful for restoration purposes.

In one or more embodiments of the invention, the production hosts (e.g., 104, 106) may include functionality to initiate multiple backups in a parallel manner. For example, the production hosts (e.g., 104, 106) may each host multiple backup processes that each manages the initiation of a respective backup. Each of the multiple backup processes may operate concurrently thereby causing multiple backups to be initiated in a parallel manner.

In one or more embodiments of the invention, the production hosts (e.g., 104, 106) may be implemented as computing devices (e.g., 400, FIG. 4). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the production hosts (e.g., 104, 106) described throughout this application.

Alternatively, in one or more embodiments of the invention, the production hosts (e.g., 104, 106) may also be implemented as logical devices, as discussed above.

In one or more embodiments of the invention, the clients (130) may interact with the production hosts (e.g., 104, 106). For example, the clients (130) may utilize application services provided by the production hosts (e.g., 104, 106). When the clients (130) interact with the production hosts (e.g., 104, 106), data that is relevant to the clients (130) may be stored on the production hosts (e.g., 104, 106). For example, consider a scenario in which the production hosts (e.g., 104, 106) host a database utilized by the clients (130). In this scenario, the database may be a user database associated with the users of the clients (130). When a new user is identified, the clients (130) may add information regarding the new user to the database. By doing so, the data that is relevant to the clients (130) may be stored in the production hosts (e.g., 104, 106). This may be done because the clients (130) may desire access to the data regarding the new user at some point in time.

In one or more embodiments of the invention, the clients (130) may include functionality to use services provided by the production hosts (e.g., 104, 106). For example, the clients (130) may host local applications that interact with applications hosted by the production hosts (e.g., 104, 106).

In one or more embodiments of the invention, the clients (130) may be implemented as computing devices (e.g., 400, FIG. 4). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the clients (130) described throughout this application.

Alternatively, in one or more embodiments of the invention, the clients (130) may also be implemented as logical devices, as discussed above.

Turning now to FIG. 2, FIG. 2 shows a diagram of specific components utilized in performing a restoration with backup data stored on cloud storage (250) in accordance with one or more embodiments of the invention. The target production host's storage (220) communicates with a backup agent (230) which receives backup data from a local backup storage device (240) and/or cloud storage (250). Each component illustrated in FIG. 2 is discussed below.

The production host may be similar to the production hosts (e.g., 104, 106) as discussed above in reference to FIG. 1. The production host (e.g., 104, 106) may include VMs, a hypervisor, a production agent, and a production storage device (220). The production host and the production storage device (220) may include additional, fewer, and/or different components without departing from scope of the invention. Each component may be operably connected to any of the other component via any combination of wired and/or wireless connections.

As discussed above, the production host may provide computer implemented services to the client(s) (e.g., 130 in FIG. 1) and obtain backup storage services from the backup storage device (240). To provide and obtain the aforementioned computer implemented services and the backup storage services, the production host may include a backup agent (102), application(s) (e.g., 112, 114), and persistent storage (128). The production host may include other and/or additional components without departing from the invention.

As discussed above, the production host (e.g., (e.g., 104, 106), FIG. 1) includes production storage (220). The production storage (220) includes local data (222) and meta-data (224A, 224N) for the local data. The local data (222) may include application data, databases, and other types of data that it would be desirous to back up and have the ability to restore. The local data (222) can be organized in one or more file systems including folders that each have file system meta-data (224A, 224N) that provides functionality to the file system. The local data (222) can be stored in multiple physical storage devices, and/or virtual storage devices located throughout a network or even a cloud. Alternatively in accordance with one or more embodiments of the invention, the local data (222) can be located on a single storage device that is part of the production storage (220).

The production storage (220) may be implemented using physical storage devices and/or logical storage devices. The physical storage devices may include any combination of hard disk drives, solid state disk drives, tape drives, and/or any other physical storage mediums for the storage of data. Alternatively, in accordance with one or more embodiments of the invention the production storage (220) may be implemented with cloud-based storage or a hybrid storage scheme where part of the data is stored on a cloud-based storage system and part stored on a local physical storage device/logical storage device.

The logical storage devices (e.g., virtualized storage) may utilize any quantity of hardware storage resources of any number of computing devices for storing data. For example, the production storage (220) may utilize portions of any combination of hard disk drives, solid state disk drives, tape drives, and/or any other physical storage medium of any number of computing devices.

In one or more embodiments of the invention, the file system meta-data (224A, 224N) is linked to the local data (222). The file system meta-data (224A, 224N) can provide such information as location or mapping data, descriptive data, administrative data, reference data, statistical data, and other types of data. The file system meta-data (224A, 224N) can be used by the production host, a client, and/or backup agent (230) to discover and link the data with the appropriate application.

As the local data (222) is changed over time, the meta-data (224A, 224N), must change with it or the local data (222) will become increasingly hard to locate and use and the wrong data may be provided to an application. This is especially an issue when restoring or replacing at least part of the local data (222) with that from a backup.

Continuing with the discussion of FIG. 2, the backup storage device (240) may include multiple backups including full backups and incremental backups or as shown in FIG. 2, may only store backup meta-data from multiple backups and/or file systems A-N (e.g., 242A, 242N). In one or more embodiments of the invention, the backup storage device (240) may be part of a physical device that is operatively connected to the production host, such as in an onsite information handling system that either contains or is operatively connected to the production host. As shown in FIG. 1, the persistent storage system (128) of the backup storage device (116) may include multiple backups (e.g., 128A, 128N) and/or their meta-data.

As discussed above, the backup storage device (240) may provide backup storage services to the target production host. The backup storage device (240) may include other and/or additional components without departing from the invention. The backup storage device (240) stores a backup created at least in part by a backup agent (230), which performs backups and/or restoration in accordance with one or more embodiments of the invention of the production storage (220).

The backup storage device (240) may be implemented using physical storage devices and/or logical storage devices. The physical storage devices may include any combination of hard disk drives, solid state disk drives, tape drives, and/or any other physical storage mediums for the storage of data. The logical storage devices (e.g., virtualized storage) may utilize any quantity of hardware storage resources of any number of computing devices for storing data. For example, the backup storage device (240) may utilize portions of any combination of hard disk drives, solid state disk drives, tape drives, and/or any other physical storage medium of any number of computing devices.

The backup storage device (240) may additionally be connected through a network such as the Internet, to cloud-based storage (250). The cloud storage (250) may be public or private (such as an internal or corporate cloud run by the owner of the production hosts). In accordance with one or more embodiments of the invention, the backup storage device (240) may be implemented with cloud-based storage or a hybrid storage scheme where part of the data is stored on a cloud-based storage system and part stored on a local physical storage device/logical storage device.

In one or more embodiments of the invention, a backup system may include one or more backup agents (230) (which are the same or substantially similar to the backup agents described in FIG. 1), which perform both the backups and restoration of backups when restoration is needed. The backup agent (230) is operatively connected to both a backup storage device (240) and the production storage (220). In one or more embodiments of the invention the backup agent (230) is also connected by a network connected to one or more could storages (250) which contain backup Data (e.g., 252A, 252N).

The backup agents (230) in one or more embodiments of the invention can include such things as an intelligent file system crawler (not shown) to obtain multiple backups including meta-data (224A, 224N) and backup data (e.g., 252A, 252N) from the target file system of the target production storage (220) and/or host (e.g., 104-106, FIG. 1). In one or more embodiments of the invention, the backup meta-data (e.g., 242A, 242N) is stored in the local backup storage device (240) while the backup data (e.g., 252A, 252N) is stored in cloud-based storage (250). Alternatively, both the meta-data (e.g., 242A, 242N) and the backup data (e.g., 252A, 252N) can be both stored on the same cloud or multiple different clouds.

The backup agent (230) includes the functionality to restore the backups data (e.g., 252A, 252N) to the production storage's local data (222) as will be discussed in more detail with regards to FIG. 3. The backup agent (230) can provide other functionality such as perform filesystem backup, filesystem history monitoring, archiving, and/or other and/or additional purposes without departing from the invention. The backup agent (230) may include other and/or additional functionalities without departing from the invention.

FIG. 3 shows a method to perform a restoration of a backup in accordance with one or more embodiments of the invention. While the various steps in the method are presented and described sequentially, those skilled in the art will appreciate that some or all the steps may be executed in different orders, may be combined, or omitted, and some or all steps may be executed in a parallel manner without departing from the scope of the invention.

As discussed above, FIG. 3 shows a flowchart of a method for restoring a backup stored, at least in part, on a cloud, in accordance with one or more embodiments of the invention. The method may be performed by, for example, the backup agent (230, FIG. 2), a volume snapshot service (VSS), an archiving service/application, and/or any other part of either the production host (104, 106, FIG. 1) or a backup storage device (116, FIG. 1). Other components of the system illustrated in FIG. 1 and FIG. 2 may perform all, or a portion of the method of FIG. 3 without departing from the invention.

While FIG. 3 is illustrated as a series of steps, any of the steps may be omitted, performed in a different order, additional steps may be included, and/or any or all the steps may be performed in a parallel and/or partially overlapping manner without departing from the invention.

In step 300, the system begins the restoration of local data (e.g., 222, FIG. 2) and file system meta-data (e.g., 224A, 224N, FIG. 2) with backup data (e.g., 252A-252N, FIG. 2) and backup meta-data (e.g., 242A, 242N, FIG. 2).

In one or more embodiments of the invention, the restoration is started based on a restoration event that is identified by the backup agent or other component or application and/or user of the production host. The event can be specified by a backup/restoration policy associated with the generation of a backup of a target file system. Alternatively, in one or more embodiments of the invention, the restoration can be started after obtaining a message from a client device and/or system administrator requesting the restoration of a target file system with backup data. The backup agent may monitor the target file system and/or local data for failure or based on other criteria (such as a cyber-attack) to identify when a restoration needs to be performed. Other processes and methods can be employed to determine when to perform a restoration without departing from the invention.

In step 302, which may be optional in one or more embodiments of the invention, a user or administrator selects the backup to be restored.

In one or more embodiments of the invention, the backup agent, upon receiving a request to perform a restoration, displays a plurality of available backups using a graphical user interface (GUI) of a user's or administrators display. Alternatively, the backup agent can display the GUI on any client device that requests the restoration and has appropriate permissions to perform such an action. Other means for selecting a backup may be used in accordance with one or more alternative embodiments of the invention.

The GUI can include information about the various available backups as well as potential destinations for the backup; if the original location of the data prior to backing up on the production storage is not ideal or available. Some of the information that can be displayed in accordance with one or more embodiments of the invention is: where the backup data is currently located (such as in cloud storage (e.g., 250, FIG. 2) or on a backup storage device (e.g., 240, FIG. 2), and where data (e.g., local data 222, FIG. 2) corresponding to the backup data was stored on the production host's storage (e.g., 220, FIG. 2). Chronological information such as a time stamp, version number, and/or other pertinent information can also be displayed for when the backup was produced. In one or more embodiments of the invention the GUI can also display the contents of the backup and/or meta-data associated with the backup.

The GUI can allow the user or administrator, in accordance with one or more embodiments of the invention, to select which backup to have the backup agent restored. In one or more embodiments of the invention, the user or administrator can choose to restore an entire backup or specific files/parts of the backup. Also, in accordance with one or more embodiments of the invention, the administrator or user can choose where to restore the data too. The location where backup agent is to restore the backup data can include, but is not limited to, its original location or a location on the production host that is different than an original location of the data on the production host.

In one or more other embodiments of the invention, an automated system can select which backup to restore and other criteria for performing the restoration, including the location in which to restore the backup data to. In these one or more embodiments of the invention step 302 may be skipped.

Once steps 300, and optionally step 302, are performed, the method proceeds to step 304-308. In step 304, the backup agent uses the backup meta-data (e.g., 242A) for the specific backup chosen for restoration, to either over-write the target meta-data (e.g., 224A, FIG. 2) or another component of the production host or a backup system. In the situation where the meta-data no-longer exists, the backup agent writes the backup-meta-data to a new location in the target production storage (e.g., 220, FIG. 2).

In step 306, the backup data (e.g., 252A, FIG. 2) is obtained from the cloud-based storage (e.g., 250 of FIG. 2). All or part of the backup data may be stored on one or more cloud-based storage devices. The location of the backup data is determined in accordance with one or more embodiments of the invention, from location data stored in the backup meta-data. Alternatively, other local or cloud-based meta-data or other similar data structures and/or services, including but not limited to a database, index, or directory, and may provide the physical or logical location of the backup data on the cloud storage. The meta-data for the backup, may point to a single cloud storage location where the backup is located or point to a plurality of cloud storage locations (including different cloud providers both private and public).

All or part of the backup data is then written to the target production storage (e.g., 220, FIG. 2) in step 308. The backup data may be written directly to the target production storage or in accordance with one or more alternative embodiments of the invention, the backup data can be written first to the backup storage device (e.g., 240, FIG. 2). Depending on backup/restoration policies or user/administrator selections in step 302, the backup data may be written to the same location that the data was originally located on the production host's storage, or it may be written to a different location that the original location of the data of the production host's storage.

In one or more embodiments of the invention steps, 304 as well as steps 306 and 308 may be performed simultaneously in the order presented FIG. 3 or in any other order including where steps 306 and 308 are performed prior to step 304. Other processes and steps may be performed during steps 304-306 without departing from the invention.

Once steps 304-308 are completed, the method proceeds to step 310. Because the meta-data and backup data may be stored in separate locations, and because the backup data and meta-data may be restored to new locations, it is necessary to re-establish the link between the backup meta-data and that of the backup data now written to the production storage. This is done in one or more embodiments of the invention by the backup-agent, which alters the backup meta-data and/or any surviving local meta-data, to properly point to the new location of the backup-data. In one or more other embodiments of the invention, other components of the production host or client devices may perform step 310.

Once step 310 is completed, the data is indicated or considered to have been restored by the backup agent and/or the production host, and the method may end.

Additionally, as discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many distinct types of computing devices exist, and the input and output device(s) may take other forms.

One or more embodiments of the invention may be implemented using instructions executed by one or more processors of the data management device. Further, such instructions may correspond to computer readable instructions that are stored on one or more non-transitory computer readable mediums.

In general, in accordance with one or more embodiments of the invention, when restoring data from a backup that is at least partially stored on the cloud, the meta-data and data forming the backup are not in-sync with the local meta-data. When restoring the data, once the backup data and backup meta-data is copied to the desired location on the production host, the backup data and backup meta-data need to be linked back up. In accordance with one or more embodiments of the invention, once the backup data and backup meta-data is copied to the target production host, the backup meta-data is linked with the backup data and then the restoration is indicated as having been completed. By performing the linkage during the restoration, prior to the restoration being indicated as being complete, delays in production workloads and productivity can be avoided.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for restoring data from backups, the method comprising:
identifying a backup to restore onto a production host;
identifying backup meta-data for the backup, wherein backup data for the backup is located on a cloud storage;
retrieving the backup data from the cloud storage and storing the backup data on the production host;
storing the backup meta-data on the production host; and
initiating linking of the backup meta-data and the backup data on the production host, wherein the data is restored once the linking is completed.

2. The method of claim 1, wherein the identifying the backup comprises displaying details of a plurality of available backups, wherein the backup is one of the plurality of available backups.

3. The method of claim 2, wherein a user selects the backup to restore from the plurality of available backups using a graphical user interface.

4. The method of claim 2, wherein the details of the plurality of available backups comprises where the backup data is located and where data corresponding to the backup data was stored on the production host.

5. The method of claim 1, wherein the backup meta-data is stored on a backup storage device operatively connected to the production host.

6. The method of claim 1, wherein the backup meta-data is stored on the production host prior to storing the backup data from the cloud storage.

7. The method of claim 1, wherein the data is restored to a location on the production host that is different than an original location of the data on the production host.

8. A non-transitory computer readable medium comprising computer readable program code, which when executed by a computer processor enables the computer processor to perform a method for restoring data from backups, the method comprising:
identifying a backup to restore on to a production host;
identifying backup meta-data for the backup, wherein backup data for the backup is located on a cloud storage;
retrieving the backup data from the cloud storage and storing the backup data on the production host;
storing the backup meta-data on the production host;
initiating linking of the backup meta-data and the backup data on the production host, wherein the data is restored once the linking is completed.

9. The non-transitory computer readable medium of claim 8, wherein the identifying the backup comprises displaying details of a plurality of available backups, wherein the backup is one of the plurality of backups.

10. The non-transitory computer readable medium of claim 9, wherein a user selects the backup to restore from the plurality of available backups using a graphical user interface.

11. The non-transitory computer readable medium of claim 9, wherein the details of the plurality of available backups comprises where the backup data is located and where data corresponding to the backup data was stored on the production host.

12. The non-transitory computer readable medium of claim 8, wherein the backup meta-data is stored on a backup storage device operatively connected to the production host.

13. The non-transitory computer readable medium of claim 8, wherein the backup meta-data is stored on the production host prior to storing the backup data from the cloud storage.

14. The non-transitory computer readable medium of claim 8, wherein the data is restored to a location on the production host that is different than an original location of the data on the production host.

15. A system comprising:
a cloud storage device; and
at least one production host which comprises:
a processor;
a local storage device; and
a memory comprising instructions, which when executed by the processor, perform a method for restoring data from backups comprising:
identifying a backup to restore on to the at least one production host;
identifying backup meta-data for the backup, wherein backup data for the backup is located on the cloud storage device;
retrieving the backup data from the cloud storage device and storing the backup data on the at least one production host;
storing the backup meta-data on the at least one production host; and initiating linking of the backup meta-data and the backup data on the at least one production host, wherein the data is restored once the linking is completed.

16. The system of claim 15, wherein the identifying the backup comprises displaying details of a plurality of available backups, wherein the backup is one of the plurality of backups.

17. The system of claim 16, wherein a user selects the backup to restore from the plurality of available backups using a graphical user interface.

18. The system of claim 15, wherein the backup meta-data is stored on a backup storage device operatively connected to the at least one production host.

19. The system of claim 15, wherein the backup meta-data is stored on the at least one production host prior to storing the backup data from the cloud storage device.

20. The system of claim 15, wherein the data is restored to a location on the at least one production host that is different than an original location of the data on the production host.
